(19) United States
(12) Patent Application Publication
(10) Pub. No.: US 2018/0118604 A1
(43) Pub. Date: May 3, 2018

(54) DOPED NANOPOROUS SILICA

(71) Applicant: Regents of the University of Minnesota, Minneapolis, MN (US)

(72) Inventor: William Orion Nachlas, Minneapolis, MN (US)

(21) Appl. No.: 15/802,731

(22) Filed: Nov. 3, 2017

Related U.S. Application Data
(60) Provisional application No. 62/417,051, filed on Nov. 3, 2016.

(51) Int. Cl. C03C 3/06

(52) U.S. Cl. CPC C03C 3/06; C03C 2201/42

(57) ABSTRACT

Techniques for precise and accurate doping of nanoporous silica gel or silica glass that include forming a silica gel slurry that includes an activated silica gel and a solvent, adding a metal dopant to the silica gel slurry to form a mixture, mixing the mixture of the metal dopant and the silica gel slurry, and removing the solvent from the mixture to form a doped silica gel.

This application claims the benefit of U.S. Provisional Patent Application No. 62/417,051, filed Nov. 3, 2016, the entire content of which being incorporated herein by reference.

### GOVERNMENT INTEREST

This invention was made with government support under EAR-0911497 awarded by the National Science Foundation. The government has certain rights in the invention.

### TECHNICAL FIELD

The present disclosure relates to techniques of forming doped silica glass that includes one or more trace elements.

### BACKGROUND

Advances in analytical instrumentation for measuring trace level concentrations (<0.1 weight percent) of solid materials have revealed the importance of quantifying chemical components at very low mass fractions. In glass materials, components present at trace concentrations can have significant impact on physical or optical properties important for engineering and industrial purposes. In natural solid glassy and crystalline materials, equilibrium thermodynamic and kinetic processes operating at trace concentration levels have been shown to record a wealth of geologic information.

The importance of trace element chemistry on material properties produces a need for more accurate and precise measurements of trace-level components from small regions (<5 micrometers (μm)) of solid materials. To obtain a high degree of confidence with these measurements, well-characterized microanalytical reference materials are needed.

### SUMMARY

In some examples, the disclosure describes techniques for fabricating high-purity doped silica glass that includes a dopant of a selected element at a specified concentration. In some examples, the dopant may include specified concentrations of titanium such that the doped silica glass includes about 30 μg/g to 3000 μg/g of the titanium dopant.

In some examples, the described techniques may be used to form doped silica glass using a nanoporous silica gel, where the doped silica glass includes a specified mass fraction of a selected metal dopant such as titanium. In some examples, the metal dopant may be substantially uniformly dispersed in the doped silica glass. In some examples, the metal dopant may be uniformly dispersed at the intra-grain, inter-grain, and grain population scales. For example, the concentration of the dopant may be within a range of about ±10 μg/g of a nominal value throughout a volume of the doped silica glass. The doped silica glass may be useful as a reference standard for bulk analysis and microanalysis of sample materials with electron, laser, or ion-beam techniques.

In some examples, the disclosure describes method including adding a metal dopant to a silica gel slurry to form a mixture, wherein the silica gel slurry includes an activated silica gel and a solvent, mixing the mixture of the metal dopant and the silica gel slurry, and removing the solvent from the mixture to form a doped silica gel.

In some examples, the disclosure describes a doped silica glass including at least one layer of silica doped with a metal dopant at a concentration of about 30 μg to about 3000 μg of the metal dopant per gram of silica, wherein the metal dopant is substantially homogeneously dispersed within the at least one layer.

### BRIEF DESCRIPTION OF DRAWINGS

FIG. 1 is a flow diagram of an example technique for forming a doped silica glass that includes a specified concentration of dopant.

FIGS. 2A and 2B illustrate a set of images of an example silica gel taken under microscopic and nanoscopic magnifications, respectively.

FIG. 3 is a chart showing the effect of molecular size (approximated by the C number) of the solvent medium on doping recovery.

FIG. 4 is a chart comparing the observed doping recovery at a range of target concentrations.

FIGS. 5A and 5B show schematic cross-sectional examples of a 3-layer and a 7-layer aggregate of doped silica glass formed using the techniques of FIG. 1.

### DETAILED DESCRIPTION

The disclosure describes techniques for fabricating high-purity doped silica glass that includes precise concentrations of a dopant such as titanium. In some examples, the techniques described may be used to form high-purity, amorphous silica that possesses both strong physical absorption and chemical affinity for dopant ions which may render such articles useful for fabricating microanalytical reference materials for trace element analysis. In some examples, the doped silica glass may be used as a reference standard for evaluating natural quartz or other test samples. For example, quartz (SiO₂) rarely naturally occurs as a pure substance in nature and often contains numerous elemental impurities at trace (e.g., less than 1000 μg/g) concentration levels. As one example, titanium (Ti) concentrations in naturally-occurring quartz from most geological settings are on order of 1-100 μg/g. Due to the relatively slow diffusion rates of most trace elements in quartz compared with the rates of the crystal growth, trace element distributions in natural quartz are commonly inhomogeneous across small spatial scales. The emergence of trace element in quartz thermometers and barometers has generated interest in accurately detecting low elemental concentrations of impurities (e.g., on the order of 1 μg/g) from relatively small (e.g., <5 micrometers (μm)) regions of quartz materials. Other advances in understanding the solubility of trace elements in minerals has also generated interest in quantifying low elemental concentrations from micrometer-scale regions of natural crystals.

Attempts at in-situ trace element analysis made by pushing the limits of conventional techniques have been met with varied success, in part due to a lack of suitable reference standards available for testing instrument calibrations. In some examples, owing to uncertainties with coupling of the ion-, electron-, or laser-beam with glass matrices, measurement uncertainties at very low mass fractions can arise. Incorporating reference materials into an analysis routine improves the commutability and confidence of measurements and refines the petrological interpretations that rely on them. The accuracy and precision of such analysis depends on the use of an accurate reference standard for comparison.

In some examples, pre-fabricated reference standards may be obtained from the National Institute of Standards and Technology (NIST) for preforming some of these evaluations and calibrations. For example, the NIST SRM 610-617 glass references have become one of the most widely used reference materials for measuring trace elements in quartz. The NIST SRM 610-617 glasses were synthesized in the early 1970s as large (ca. 100 kg) batches of soda-lime glasses spiked with sixty-one trace elements at four different concentration levels. While the NIST SRM 610-617 glasses may be useful in certain applications, the NIST SRM 610-617 glasses were not intended for precise microanalysis and several difficulties and technical challenges have arisen in using these glasses for microanalysis because of inhomogeneities at the mass resolution scale of some analyses. For example, inhomogeneities of some trace elements have been detected in the high concentration NIST SRM 610 and 612 glasses. Additionally, the relatively high number of different trace elements contained in the NIST glasses can generate spectral interferences within the sample. Further, the NIST SRM 610-617 glasses are derived from a finite supply of material and the exact recipe for reproducing the glasses is unknown. As measurement techniques become more refined, the use reference materials that contain a specific concentration or bracket a range of concentrations of dopants that are close to the anticipated levels expected in unknown samples may be needed. Additionally, analytical interferences might be avoided by using materials whose impurity contents can be selectively controlled.

In some examples, the techniques described herein may be used to form reference standards of doped silica glass having an accurate and precise amount of a selected dopant. The doped silica glass described herein may be prepared using nanoporous silica gel, which under certain synthesis conditions, provides an ideal substrate for fabricating trace element doped materials because of the high absorptive capacity of the nanopores and the strong adsorptive capacity of the surface silanol groups of the silica gel. The doped silica glass described herein may be used to improve the confidence levels of petrogenetic reconstructions derived from measurements of trace-level titanium content analysis in quartz test samples. In some examples, the preparation methods outlined below may enable doping precision of about ±5 μg/g or better within a target concentration that is less than about 1000 μg/g. In some examples, due to the commercial availability for standard solutions of various doping materials available in multiple concentrations for most of elements on the periodic table, it is possible that using nanoporous silica gel as the doping substrate as described herein may allow for the fabrication of high-purity glasses with specified dopants at trace-level precision and high accuracy.

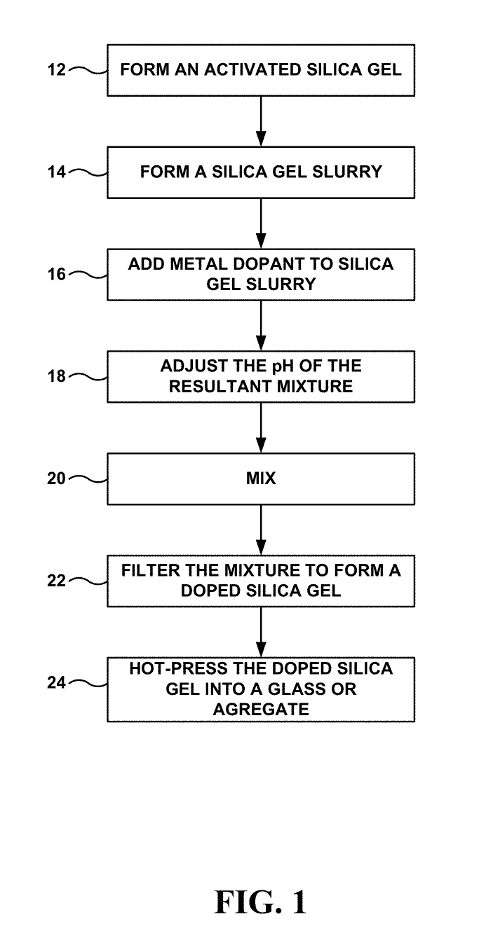

FIG. 1 is a flow diagram of an example technique for forming a doped silica glass that includes a specified concentration of a dopant. The technique of FIG. 1 includes forming an activated silica gel (12), forming a silica gel slurry (14) using the activated silica gel, adding a dopant (e.g., titanium or other transition metals) to the silica gel slurry (16), adjusting the pH of the resultant mixture (18), mixing (20) the slurry mixture, filtering the mixture to form a doped silica gel (22), and hot-pressing the doped silica gel into a doped silica glass.

In some examples, using silica gel as the doping substrate may provide a high absorptive capacity for metal ions, in part because the pores of silica gel are strongly absorptive due to the nanoporous network. Any suitable type of silica gel may be used with the techniques of FIG. 1. Nanoporous silica gel may be characterized as an amorphous form of hydrated silica having an interconnected network of hydrophilic nanopores. As described further below, under controlled experimental conditions, the physical absorption of the nanopores and the chemical adsorption of the silanol groups populating the silica surface combine to render nanoporous silica gel as a highly-retentive doping substrate.

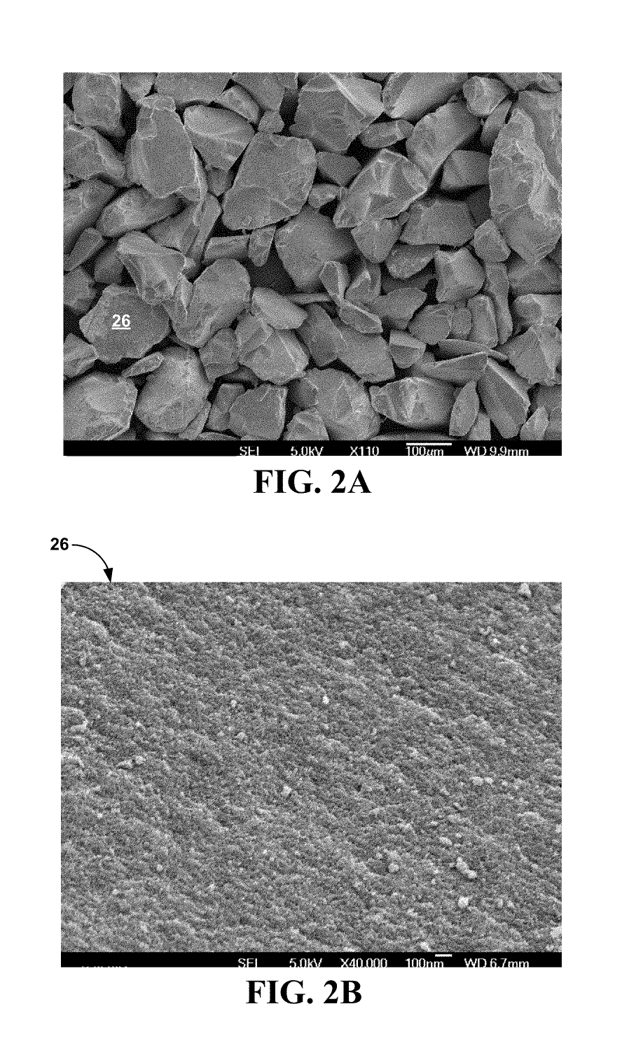

FIGS. 2A and 2B illustrates a set of images of silica gel 26 taken at microscopic and nanoscopic magnifications respectively. Silica gel 26 may be characterized as a form of high-purity, amorphous silica (SiO₂), with an internal network of interconnected nanopores. In some examples, silica gel 26 may have an average grain size of about 60-200 μm that defines nanopores on the order about 60 Å.

In some examples, silica gel 26 may be synthesized through a sol-gel processing technique involving hydrolysis of silicic alkoxide precursors from which gelaceous silica condenses and is then dried to form a powder. By controlling the pH conditions and the rate of gelation during the sol-gel process, silica gel 26 particles can be synthesized with high levels of purity. In some examples, silica gel 26 may be obtained commercially with specific grain or pore size dimensions. Additionally, or alternatively, the silica gel may be produced or purchased commercially at various purity levels and standards. For example, commercially available silica gel may be acquired in high-purity or ultra high-purity forms with residual impurities ranging from about 0.5 percent by weight (wt. %) to about 0.001 wt. % or less residual impurities. In some examples, the purity level of the silica gel may be reduced via acid washing as described further below. Other techniques may also be available for producing silica gel with high purity levels.

In some examples, silica gel 26 may be essentially free of trace metals (e.g., less than 0.001 wt. % of any specific metal (e.g., less than 0.001 wt. % titanium) such that the background impurities are within the precision of the doping techniques described herein. In other examples, silica gel 26 may include higher levels of initial trace metals/impurities. In such examples, the doping techniques described herein may be applied to such materials as a method of adding a specified amount of the dopant material to the background levels of the initial trace metals/impurities.

As shown in FIG. 2B, silica gel 26 may be nanoporous. In some examples, the nanoporosity of silica gel 26 exerts a capillary force that may promote imbibition to evenly distribute polar dopant molecules throughout the grain interiors. For example, the surface of silica gel 26, as shown in FIG. 2B, may be highly porous allowing for a highly retentive bonding environment as a doping substrate. For example, the highly porous surface of surface silica gel 26 may be densely-populated with silanol groups that have a strong affinity for metallic ions. Additionally, silica gel 26 possesses relatively thin silica walls, the silica material separating pore spaces, that in some examples, may act to minimize the effective diffusion distance and facilitate homogenization of a dopant within the silica framework. In some examples, the thicknesses of the walls of silica gel 26 may be on the order of several to tens of silicon atoms. In some examples, silica gel 26 may define a porosity of about 0.5 m³/g (vol. of pores per weight of sample) or more.

The technique of FIG. 1 includes forming an activated silica gel (12). In some examples the activated silica gel may be formed by initially acid-treating silica gel 26 with a concentrated acid. Suitable acids may include, but are not limited to, hydrochloric acid, nitric acid, or aqua regia (e.g., hydrochloric acid and nitric acid). In some examples, silica gel 26 may be combined and mixed with HCl on the order of hours to days to activate the silica gel. In some examples, the acid treatment of silica gel 26 may remove many of the initial impurities and vacate the silanol groups prior to subsequent doping. In some examples, rinsing the silica gel in concentrated acid (e.g., 6 mol/L or greater HCl) for increasing durations of time (e.g., 3, 6, 9, 72, 168 hours) may be effective at removing most of the initial impurity content within silica gel 26. Table 1 illustrates the impurity content of silica gel compared to Black Hills Quartzite (BHQ) both initially and after 9 hours of acid-rinsing using 6 mol/L of HCL.

TABLE 1
Trace element contents of silica gel and pure quartz separate
from Black Hills Quartzite (BHQ) as measured with ICP-OES

| Material | Al | Ba | Ca | Fe | K | Mg | Mn | Na | P | Sr | Ti | Zr |
|---|---|---|---|---|---|---|---|---|---|---|---|---|
| Silica gel (as | 223.2 | 15.5 | 532.7 | 213.8 | 35.7 | 167.0 | — | 786.4 | 12.1 | 7.6 | 142.0 | 64.7 |
| received) | | | | | | | | | | | | |
| Silica gel (9 h | 61.0 | 3.3 | 193.4 | 200.7 | — | 94.7 | — | 52.4 | 10.0 | 3.7 | 114.5^{a} | 62.7 |
| activation*) | | | | | | | | | | | | |
| BHQ (as | 728.0 | 9.3 | 849.0 | 912.1 | 183.7 | 250.4 | 15.0 | 61.9 | 102.4 | 7.7 | 140.7 | 8.8 |
| received) | | | | | | | | | | | | |
| BHQ (9 h | 457.4 | 8.5 | 619.8 | 588.0 | 37.6 | 219.1 | 12.6 | 48.1 | 15.4 | 6.5 | 47.2 | 3.3 |
| activation*) | | | | | | | | | | | | |

*fluxed with 6 mol/L HCl for 9 h.
All values in μg/g;
^{a}±1.03 (n = 7).

Following the acid-rinsing, silica gel 26 may washed thoroughly with, for example, de-ionized water (DIW) until no amounts of the acid are detected in the decanted rinsings using, for example, AgNO₃ as the indicator. In some examples, the DIW wash cycles may take more than 25 total washings to sufficiently remove the acid. After substantially all acid has been removed, the resultant activated silica gel may be dried using a conventional furnace under a low-temperature (e.g., about 100-120° C.), long duration (e.g., on the order of 100 hours) heat treatment to evacuate residual volatiles from the pores of the activated silica gel without damaging the fragile silica pore network. In some examples the activated silica gel may be stored for an interim period in an air-tight container.

The techniques of FIG. 1 also include forming a silica gel slurry (14) that includes the activated silica gel and a solvent. The solvent may include any suitable polar or non-polar, non-reactive (e.g., inert to the silica gel and the dopant) liquid medium including, for example, ethanol (e.g., Sigma-Aldrich, no. 459844), denatured ethanol (e.g., Fisher Scientific, no. A406P-4), heptane (e.g., Sigma-Aldrich, no. 592579), hexadecane (e.g., Sigma-Aldrich, no. H6703), squalane (e.g., Sigma-Aldrich, no. 234311), or de-ionized water.

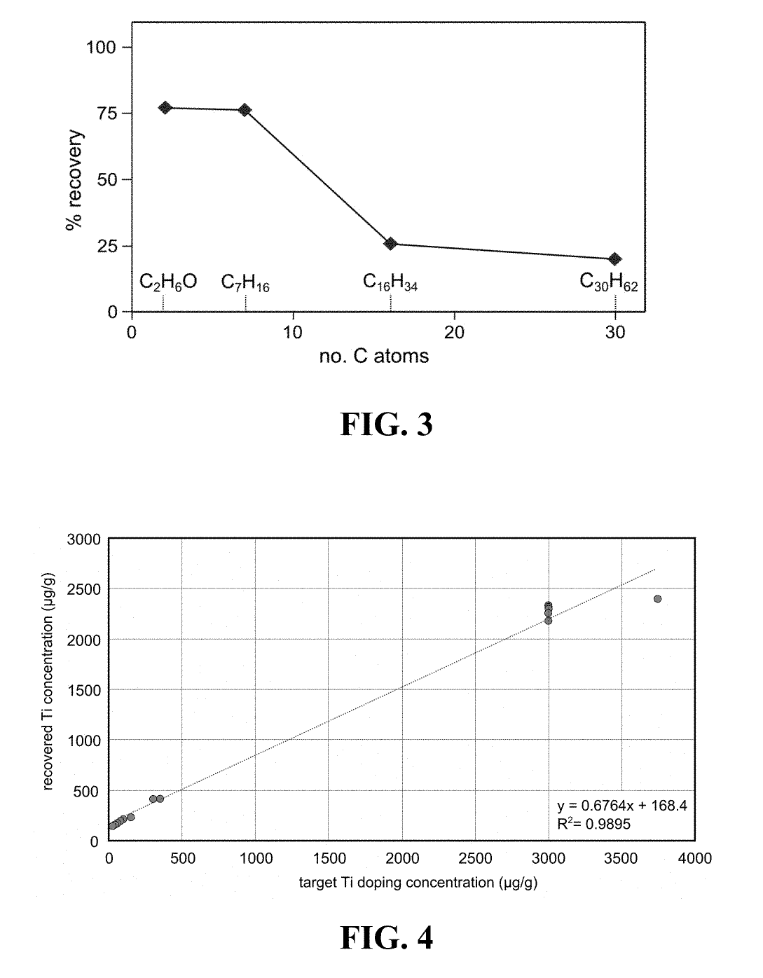

In some examples, the activated silica gel may be added to the solvent in aliquots greater than about 3 μL. In some examples, it may be preferable to use a solvent having shorter chain alkanes (e.g., chain lengths less than the pore size of silica gel) to increase the amount of dopant retained by the activated silica gel. In some examples, the solvent may be ethanol, which is a short-chain, inexpensive, and relatively low-hazard material. In some examples, longer chain alkanes (e.g., heptane, hexadecane, squalane) may result in a decrease in doping efficiency due to physical obstruction of the nanopores in the activated silica gel. In some examples in which the solvent is organic, the solvent may include a carbon chain of 7 or less. FIG. 3 is an example chart showing the effect of molecular size of the solvent medium (approximated by the number of chain carbon atoms of the solvent) on doping recovery of a titanium dopant at a 3000 μg/g target concentration.

After formation of silica gel slurry (14), a dopant material may be added to the silica gel slurry (16). In some examples, the dopant may include any suitable dopant including, but not limited to, aluminum (Al), antimony (Sb), arsenic (As), barium (Ba), beryllium (Be), bismuth (Bi), boron (B), cadmium (Cd), calcium (Ca), carbon (C), cerium (Ce), cesium (Cs), chromium (Cr), cobalt (Co), copper (Cu), dysprosium (Dy), erbium (Er), europium (Eu), gadolinium (Gd), gallium (Ga), germanium (Ge), gold (Au), hafnium (Hf), holmium (Ho), indium (In), iridium (Ir), iron (Fe), lanthanum (La), lead (Pb), lithium (Li), lutetium (Lu), magnesium (Mg), manganese (Mn), mercury (Hg), molybdenum (Mo), neodymium (Nd), nickel (Ni), niobium (Nb), osmium (Os), palladium (Pd), phosphorous (P), platinum (Pt), potassium (K), praseodymium (Pr), rhenium (Re), rhodium (Rh), rubidium (Rb), ruthenium (Ru), samarium (Sm), scandium (Sc), selenium (Se), silicon (Si), silver (Ag), sodium (Na), strontium (Sr), sulfur (S), tantalum (Ta), tellurium (Te), terbium (Tb), thallium (Th), thulium (Tm), tin (Sn), titanium (Ti), tungsten (W), vanadium (V), ytterbium (Yb), yttrium (Y), zinc (Zn), zirconium (Zr), or other elements of interest. In some examples, the dopant may be a metal such as a transition metal (e.g., titanium). In some examples, the dopant may be provided as a standard solution (e.g., metal plasma standard solution). For example, in the examples of a titanium dopant, the titanium dopant may be provided as a plasma standard solution, for example, Ti in 5 g/100 g HNO₃. Such standards may be commercially-available for most metal dopants in different concentrations. For example, standards of titanium may be purchased in concentrations of 10 μg/mL (e.g., Alfa Aesar, no. 45267) or 1000 μg/mL (Alfa Aesar, no. 35768).

In some examples, the dopant (e.g., titanium) may be added to silica slurry gel using a micropipette to add precise amounts of the metal standard solution (e.g., Ti in 5 g/100 g HNO₃). In some examples, the use of a micropipette may provide a 1-3 μL precision which may translate to a minimum measurement bias in doping precision of 3-8 μg/g depending on the concentration of the standard solutions. In some examples, the resulting precision of the dopant added may be about ±5 μg/g based on the amount of silica (e.g., FIG. 4). Additionally, or alternatively, in some examples the resulting precision of the dopant added may be about ±5 μgig based on the amount of silica for target doping concentration less than about 1000 μg/g.

After adding the dopant to the silica gel slurry, the pH of the mixture optionally may be adjusted (18) to values between about 7 to about 10 using titration. The pH of the mixture may influence the silanization of the silica surface as well as the stability of the dopant (e.g., titanium) species in the plasma standard solution (in examples in which a plasma standard solution is used). In some examples, the pH of the mixture may be adjusted to about a pH of 8.

For example, the resultant mixture may be titrated using 3 mol/L NH₄OH and 0.3 mol/L NH₄OH as base buffers and 0.2 mol/L HNO₃ as an acid buffer to stabilize the pH. Optionally, in some examples, once the pH of the mixture is adjusted (18) at the desired level, the vessel containing the activated silica gel, dopant, and solvents may be placed into an oscillating apparatus (e.g., for about 3 hours) to ensure sufficient mixing (20). After being thoroughly mixed, the contents of the mixture may be filtered (22) using, for example, vacuum filtration to remove the solvents. The resultant material may be placed in a conventional furnace (e.g., at 100° C. for 24 hour then at 120° C. for 120 hour) to produce a doped-silica gel. The doped silica gel may be stored in an air-tight container prior to further processing.

The technique of FIG. 1 also optionally includes hot-pressing the doped silica gel to form doped silica glass (24). Example hot-press assemblies include, for example, a Paterson gas-medium triaxial deformation apparatus. In some examples, the hot-press process may be performed at about 1100° C. and about 300 MPa for approximately 1-3 hours to compact and densify the doped silica gel into a doped silica glass (e.g., doped amorphous silica). In some examples, the doped silica glass may be prepared by hot-pressing doped silica gel between iron (Fe) spacers, which may then be inserted into an outer Fe jacket and sandwiched by alumina pistons. Once loaded into the hot-press apparatus, the layers may be compressed with a load of about 100 MPa or more.

In some examples, doped silica gel may be hot-pressed as multiple glass layers (e.g., 3-7 layers of doped silica glass), each having its own specified concentration of dopant. For example, collections of doped silica gel each at different concentrations may be hot-pressed for short duration to compact and densify (without crystallizing) the silica glass layers. In some such examples, crystallization of the silica during hot-pressing should be avoided as the solubility of the dopant in the growing crystals may impact the desired dopant concentration in resultant silica layers. In some such examples, the glass layers may be hot-pressed at 100 MPa over a temperature ramp to a target of about 1100° C. over a duration of about 1.5 hour, followed by a pressure increase to about 300 MPa to form the layered aggregates without inducing crystallization of the silica gel. In some examples, each layer may define a thickness of about 0.5 mm to about 3 mm with each layer including a selected dopant concentration of between about 30-3000 μg/g of the dopant relative to the mass of silica (e.g., about 30-3000 μg dopant/g silica) with the dopant substantially homogeneously dispersed throughout the respective layer. In some examples, the respective layers may consist essentially of silica and the dopant such that any other impurity is less than or equal to the level of doping precision. For example, the respective layers may consist of silica, the dopant, and less than about 10 μg/g of any other impurity (e.g., trace metals). Additionally, or alternatively, the respective layers may include silica, the dopant, and background impurities. In such examples, each layer may include a specified and incremental change in dopant concentration (e.g., step changes of 30 μg/g or more) in addition to any background impurities. In any of the above examples, the dopant may be substantially homogeneously dispersed within a given layer. In some examples, the glass layers may also include a blank/reference layer where the dopant material has not been added.

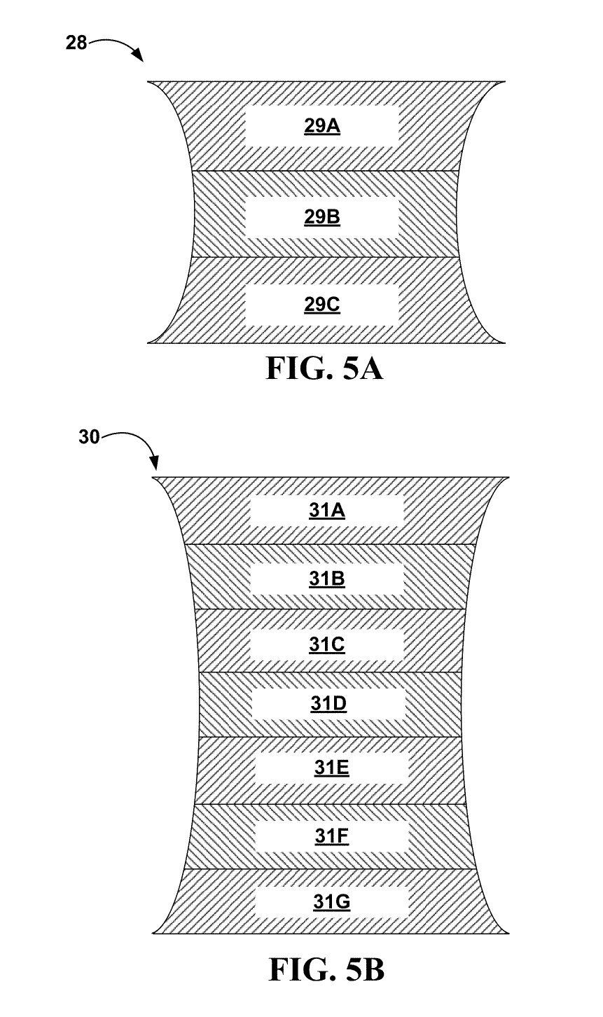

The technique of FIG. 1 may enable fabrication of silica glasses containing a selected element at a specified, precise, and reproducible concentration. In some examples, the techniques may be used to develop multi-layered reference doped silica glass with each layer doped with specific and different quantities of dopant (e.g., titanium). FIGS. 5A and 5B show a schematic cross-sectional two example multi-layered aggregates including a 3-layer aggregate 28 (FIG. 5A) that includes layers 29A-29C and a 7-layer aggregate 30 (FIG. 5B) that includes layers 31A-31G of doped silica glass that may be prepared using the dopant techniques described above and/or the multi-layer aggregate glass formation techniques described below in Example 6. In some examples, the multi-layer glass aggregates may include more or a fewer number of layers with each layer including a specified amount of dopant. In some examples, the aggregate layers may include between 30-3000 μg/g of added dopant material. The precision of each doped layer may be about ±10 μg/g of a target amount of the dopant throughout a volume of the doped layer (e.g., homogeneously dispersed throughout the layer). In some examples, the layers may be arranged based on dopant concentrations to define a step-wise, concentration gradient across the multi-layer glass aggregate. Additionally, or alternatively, the dopant may be substantially homogeneously mixed (e.g., homogenous or nearly homogenous) within a given glass aggregate layer. Such multi-layered glass aggregates 28, 30 may be used as a microanalytical reference material for trace element analysis with electron-, ion-, and laser-beam analysis techniques.

### Example 1

Activation of silica gel 26. Approximately 30 g of silica gel was placed into a pristine 250 ml Erlenmeyer flask using plastic disposable spatula. Approximately 100 mL of 6 mol/L HCl was added to the to the flask using a graduated cylinder along with a 1.25 inch PTFE magnetic stir bar. The flask containing the mixture was place onto a stirring plate and stirred on low power under a fume hood with a piece of parafilm adhesive paper placed over the flask to reduce evaporation. Stirring of the mixture commenced for durations of 3-168 hours. After stirring, the flask was removed from the stirring plate and approximately 100 mL DIW was added. The mixture was returned to the stir plate and stirred on low power for 1 min before the stir bar was removed. The flask was then placed into a sonicator for 5 min to settle before being decanted. Approximately 100 ml of DIW was added and swirled vigorously in the flask for 30 seconds, and the flask was returned to the sonicator for an additional 5 min. The mixture was decanted and tested for chloride in rinsings using 0.100 mol/L AgNO₃. The rinsing procedures were repeated with DIW until no chloride appeared in the rinsing (>25× total rinsings). Once obtained, the mixture was decanted to remove as much liquid as possible before placing the flask into conventional oven at 100° C. for 24 hours. The resultant powder was transferred from the flask into a glass petri dish, placed into a conventional oven at 120° C. for 120 hours. The activated silica was then weighed and stored in an air-tight container.

### Example 2

Example titanium dopant procedure for activated silica gel. Approximately 1.500 g of activated silica gel with 40 mL ethanol solvent was added into a 60 mL Nalgene plastic jar with screw lid to create a silica gel slurry. A titanium plasma standard solution was added to the jar at a desired concentration. The amount of titanium plasma standard solution added was calculated based on the following examples, to dope 1.500 g silica gel at a level of 802 μg/g, 1200 μL of a 1000 μg/mL Ti plasma standard solution and 372 μL of a 10 μg/mL Ti plasma standard solution were added. To dope 1.500 g silica at a level of 2916 μg/g, 4370 μL of the 1000 μg/mL plasma standard solution and 681 μL of the 10 μg/mL plasma standard solution were added. The cap was screwed onto the jar and shaken vigorously for several seconds. The solutions were titrated to the desired pH (e.g., pH of 8) with ammonium hydroxide (3 mol/L and 0.3 mol/L NH₄OH) and nitric acid (0.2 mol/L HNO₃). As an example for the titration, to reach a pH of 8 at the 802 μg/g doping concentration level, the pH was buffered with about 355 μL of 0.3 mol/L NH₄OH; at the 2916 μg/g doping concentration level, the pH was buffered with about 920 μL of 0.3 mol/L NH₄OH. After pH of 8 stabilized, the cap was screwed onto jar and placed into an oscillating apparatus for 3 hours. The jar was removed from oscillating apparatus and the contents filtered using vacuum filtration assembly equipped with, e.g., 0.45 μm nylon filter paper. The contents were rinsed with DIW and the rinse was included in the filtration apparatus. About 1 L of DIW was used to rinse a 1.5 g sample. Once completed, the filter was extracted from the filtration apparatus and the filter and powder were placed in a glass petri dish and dried in conventional oven at approximately 100° C. for 24 hours. The filter paper was removed, and the petri dish of power material was placed into a conventional oven at 120° C. for about 120 hours. The titanium doped silica gel was extracted to obtain the final mass before being stored in air-tight container.

### Example 3

Table 2 below shows the results of coupled plasma-optical emission spectrometry (ICP-OES) performed on 100 mg samples of doped silica glass prepared using the techniques of FIG. 1. The doped silica glass was prepared using titanium as the metal dopant with target concentrations ranging from about 30-3000 μg/g in the final doped silica glass, ethanol as the solvent, and 8 as the pH for the mixture. Measurements were performed with a Thermo Scientific iCAP 6500 dual view ICP-OES available from Thermo Fisher Scientific Inc., Waltham, Mass., USA. Samples were diluted 40-fold with the addition of a caesium matrix modifier and yttrium as an internal standard. Each analysis was repeated three times and the concentrations aggregated to improve precision. USGS reference materials Icelandic Basalt (BIR-1) and Rhyolite Glass Mountain (RGM-1) were analyzed as reference materials for the ICP-OES routine and indicate about a 2% intermediate precision for measurements of titanium. Doping recovery of the titanium was very effective at lower concentrations (e.g., between about 30-300 μg/g targets).

TABLE 2
Results of doping silica gel and pure quartz
(BHQ) with different Ti mass fractions

| | Dopant mass | | | |
|---|---|---|---|---|
| | fraction | Recovered Ti | % | ICP-OES |
| Sample name | (μg/g) | (μg/g) | Recovery | sample ID |
| Target 30 | 30 | 35 | 117 | SG-25 |
| Target 60 | 60 | 67 | 112 | SG-26 |
| Target 85 | 85 | 94 | 111 | SG-20 |
| Target 90 | 90 | 101 | 112 | SG-27 |
| Target 147 | 147 | 145 | 99 | SG-42 |
| Target 347 | 347 | 327 | 94 | SG-43 |
| Target 300 | 300 | 294 | 98 | SG-0.03 |
| Target 3000 | 3000 | 2060 | 69 | SG-0.11 |
| Target 3000 | 3000 | 2134 | 71 | SG-0.12 |
| Target 3000 | 3000 | 2167 | 72 | SG-5 |
| Target 3000 | 3000 | 2216 | 74 | SG-6 |
| Target 3000 | 3000 | 2190 | 73 | SG-10 |
| Over-dope | 3746 | 2283 | 61 | SG-13 |
| Double-dope | 2254 + 746 | 2806 | 94 | SG-14 |
| BHQ Target 300 | 300 | 76 | 25 | SG-24 |
| BHQ Target 3000 | 3000 | 1800 | 60 | SG-18 |

FIG. 4 is a chart showing the comparative analysis between the target amount of titanium metal dopant added to the silica gel and the amount of titanium metal dopant measured within the final silica gel. The techniques showed good precision (e.g., about ±10 μg/g of target value) for most test samples with even better precision (e.g., about ±5 μg/g of target value) for doping concentration below 1000 μg/g.

### Example 4

The concentration levels of titanium dopant were measured in doped silica glass using an electron probe microanalysis (EPMA) with a Cameca SX-100 electron microprobe equipped with enlarged diffracting crystals (LPET) and LaB₆ electron source. Titanium K-α X-rays were collected for 120 seconds on peak and 60 seconds on high/low background from four spectrometers and aggregated. Si K-β was measured on the final spectrometer (TAP). Analysis of unknown samples was performed at 15 kV and 200 nA with a 10 μm spot size. Standardization for titanium was performed on rutile at low current (15 nA) to help prevent peak shifts in the pulse-height analyzer at high count rates. Calculated detection limits for titanium in quartz following this routine demonstrated a detection precision of about 7 μg/g.

### Example 5

A comparative study was performed to compare the effectiveness of silica gel 26 as the doping substrate versus crystalline quartz as the doping substrate. Pure quartz separates from Black Hills Quartzite (BHQ) at 20-50 μm grain size were activated in HCl and doped with 300 and 3000 μg/g following the same techniques of FIG. 1 used for silica gel. Doping recovery using BHQ as the silica substrate was significantly lower than when using silica gel as the doping substrate. Results of the study are shown in Table 2 above.

### Example 6

Doped silica gel was tested for use as reference materials by fabricating multi-layered aggregates doped with different concentrations. FIGS. 5A and 5B show schematic cross-sectional examples of a 3-layer aggregate 28 and a 7-layer aggregate 30 of doped silica glass. The three-layered glass (FIG. 5A) included 115 (layer 29A), 802 (layer 29B), and 2181 (layer 29C) μg/g of titanium dopant as measured with ICP-OES of doped silica gel was analyzed by electron microprobe with measurements made along linear transects across the aggregate layering. The seven-layered glass (FIG. 5B) was prepared with six layers of titanium doped silica gel with 89 (layer 31A), 115 (layer 31B), 120 (layer 31C), 234 (layer 31D), 416 (layer 31E), and 2181 (layer 31F) μg/g of titanium dopant as measured with ICP-OES and one layer of crushed Herkimer quartz (layer 31G) containing 5 ng/g, of Ti.

Various examples have been described. These and other examples are within the scope of the following claims.

What is claimed is:

1. A method comprising:
adding a metal dopant to a silica gel slurry to form a mixture, wherein the silica gel slurry comprises an activated silica gel and a solvent;
mixing the mixture of the metal dopant and the silica gel slurry; and
removing the solvent from the mixture to form a doped silica gel.

2. The method of claim 1, further comprising hot-pressing the doped silica gel to form a doped silica glass.

3. The method of claim 1, wherein the metal dopant comprises a metal plasma standard solution of a transition metal.

4. The method of claim 1, wherein adding the metal dopant comprises adding a dopant mixture comprising the metal dopant and a second solvent to the silica gel slurry.

5. The method of claim 1, wherein adding the metal dopant to the silica gel slurry comprises adding about 30 μg to about 3000 μg of the metal dopant per gram of silica to the silica gel slurry.

6. The method of claim 5, wherein the metal dopant is substantially homogeneously dispersed within the doped silica gel.

7. The method of claim 1, further comprising washing a silica gel with an acid to form the activated silica gel.

8. The method of claim 7, wherein, prior to adding the metal dopant to the silica gel slurry, the activated silica gel comprises less than 100 μg/g of the metal dopant.

9. The method of claim 1, further comprising titrating the mixture to a pH between about 7 and about 10.

10. The method of claim 9, wherein titrating the mixture comprises titrating the mixture to a pH of about 8.

11. The method of claim 1, wherein the solvent comprises a carbon chain of 7 carbon atoms or less.

12. The method of claim 1, wherein removing the solvent from the mixture comprises filtering the mixture and heating the mixture at a temperature between about 100° C. and about 120° C.

13. The method of claim 1, further comprising hot-pressing the doped silica gel to a form a doped silica glass.

14. The method of claim 1, wherein the doped silica gel comprises a first doped silica gel, the method further comprising:
forming a second doped silica gel comprising the metal dopant;
depositing the second doped silica gel on the first doped silica gel; and
hot pressing the first and second doped silica gels to form a multilayer doped silica glass, wherein the first and second doped silica gels for different layers of the multilayer doped silica glass, and wherein each layer of the multilayer doped silica glass comprises a different concentration of the metal dopant.

15. The method of claim 14, wherein each respective layer of the multilayer doped silica glass comprises ±10 μg/g of a nominal value of the metal dopant throughout a volume of the respective layer.

16. The doped silica gel of claim 15, wherein the doped silica gel defines an average grain size of about 60 μm to about 200 μm.

17. A doped silica glass comprising at least one layer of silica doped with a metal dopant at a concentration of about 30 μg to about 3000 μg of the metal dopant per gram of silica, wherein the metal dopant is substantially homogeneously dispersed within the layer.

18. The doped silica glass of claim 17, wherein the doped silica glass comprises a plurality of layers of doped silica glass, wherein each layer of the plurality of layers comprises a different concentration of the metal dopant.

19. The doped silica glass of claim 18, wherein each layer of the plurality of layers consists essentially of silica and the metal dopant.

20. The doped silica glass of claim 17, wherein, for each respective layer of the plurality of layers, the metal dopant is substantially homogeneously dispersed within a volume of the respective layer.
